(19) United States
(12) Patent Application Publication
(10) Pub. No.: US 2003/0233477 A1
(43) Pub. Date: Dec. 18, 2003

(54) Extensible infrastructure for manipulating messages communicated over a distributed network

(75) Inventors: Keith W. Ballinger, North Bend, WA (US); Erik B. Christensen, Seattle, WA (US); Stefan H. Pharies, Seattle, WA (US); Alexander M. DeJarnatt, Seattle, WA (US)

Correspondence Address: LEE & HAYES PLLC, 421 W RIVERSIDE AVENUE SUITE 500, SPOKANE, WA, 99201

(73) Assignee: Microsoft Corporation, Redmond, WA

(21) Appl. No.: 10/174,348

(22) Filed: Jun. 17, 2002

(51) Int. Cl. G06F 15/16

(52) U.S. Cl. 709/246

(57) ABSTRACT

Described is a Web-enabled application that transmits or receives serialized messages and declaratively identifies another module of code to execute on a message either when received or prior to being transmitted. Briefly stated, a system embodies an infrastructure where a module of code associated with a Web service may be annotated with identifiers for other modules of code (“extensions”). When executed, the Web service code invokes the extension, which is configured to operate on an incoming or outgoing message. The extensions are configured to capture a stream of information related to the message, operate on the stream of information as programmed, and make the modified stream available for either serialization or deserialization.

### BACKGROUND OF THE INVENTION

The Internet and the World Wide Web have gained widespread acceptance. Today, users are presented with very many services offered over the Web for very many different types of activities. For example, online banking is growing fast and becoming accepted as an alternative to in-person banking. Many retailers are finding that online ordering of products such as clothing, books, and other merchandise is growing dramatically. Only the imagination limits the kind of services being requested and offered over the Web.

To support these growing demands, software developers are refining mechanisms for communicating between disparate computing systems and operating systems over the Web. New programming paradigms have emerged for developing code that can execute on computing systems of different capabilities. In particular, new programming languages and infrastructures allow source code to be written that may be transmitted upon request to computing systems of disparate manufacture. The source code is then compiled and executed natively on the receiving computer.

Based on these new programming languages and infrastructures, distributed applications are being developed where a client portion of the application may be downloaded to a requesting computer and execute in conjunction with a server portion that remains on a server computer. Under this model, an essentially bare computer can connect to the Web, request to interact with a server computer that offers a Web service based on such a distributed application, and begin to conduct business or pleasure with whatever service is being offered. Some say that this new model of service provider is the greatest technological revolution of modern time.

When portions of an application are distributed, each of the distributed portions must communicate with each other. It is possible that every distributed application could be developed with its own unique messaging system for inter-application communications. However, more efficient and robust mechanisms are being developed to standardize messaging between distributed portions of an application. Standardizing messages transmitted over the Web also allows disparate applications that are not part of the same distributed application to interact and communicate. The eXtensible Markup Language (XML) is growing in popularity as a standard for creating structured documents to share typed data. XML is popular in large part because it lends itself very well to the creation of standard serialized messages that may be transmitted over a distributed network, such as the Internet.

One XML-based protocol that has emerged to exchange information over the Web is the Simple Object Access Protocol (SOAP). SOAP is a lightweight protocol for exchange of information in a decentralized, distributed environment. SOAP may be used in combination with a variety of existing lower-level protocols and formats, such as TCP/IP and HTTP. SOAP can support a wide range of applications from messaging systems to remote procedure calls. It should be noted that the terms “procedure,” “method,” “routine,” and “function” may each be used throughout this document to describe a group of computer-executable instructions. Although in the art of computer science there may be some differences, it is the intent that those terms be used interchangeably in this document, and no distinction should be drawn from the use of one particular term over another in any particular circumstance.

A Web service application may communicate over a wide area network by transmitting and receiving serialized messages formatted in accordance with the SOAP protocol, or some similar protocol. Typically, the Web service application operates using objects or object code, and those objects or object code are converted to a serialized message, such as a SOAP message, for transmission over the Web.

Sometimes developers desire to add third-party functionality to a Web service application, or to add some other functionality that operates on a message created by the Web service. However, there has not existed a mechanism that allows a Web service application to declaratively indicate that some third-party functionality should be performed on the message either before the message has been transmitted, or after a response has been received. In particular, mechanisms have not existed that employ a declarative syntax to invoke functionality on a message either after it has been serialized for transmission over the wide area network, or before it has been deserialized upon receipt.

### SUMMARY OF THE INVENTION

The present invention is directed at allowing a Web-enabled application that transmits or receives serialized messages to declaratively identify another module of code to execute on a message either when received or prior to being transmitted. Briefly stated, the invention enables an infrastructure where a module of code associated with a Web service may be annotated with identifiers for other modules of code (“extensions”). When executed, the Web service code invokes the extension, which is configured to operate on an incoming or outgoing message. In further accordance with the invention, the extensions are configured to capture a stream of information related to the message, operate on the stream of information as programmed, and make the modified stream available for either serialization or deserialization, as the case may be.

### BRIEF DESCRIPTION OF THE DRAWINGS

FIG. 1 is a functional block diagram of a computing environment in which implementations of the present invention may be embodied.

FIG. 2 is a functional block diagram overview of a distributed networking environment in which implementations of the invention may be embodied.

FIG. 3 is a functional block diagram illustrating software components that support the Web service offered by the server and, used by the client computer, in accordance with embodiments of the invention.

FIG. 4 illustrates one example of a request message that may be used in the operation of implementations of the present invention.

FIG. 5 illustrates one example of a response message that may be used in the operation of implementations of the present invention.

FIG. 6 illustrates one simple example of Web service code that may implement a portion of one embodiment of the present invention.

FIG. 7 illustrates one example of a Web service extension that may implement a portion of one embodiment of the present invention

FIG. 8 is a logical flow diagram generally illustrating a process for declaratively invoking identified extension code on a remote computer in a distributed computing environment, in accordance with one implementation of the invention.

FIG. 9 is a logical flow diagram generally illustrating a process for declaratively invoking identified extension code on a local computer in a distributed computing environment in conjunction with creating and transmitting a serialized message of a network, in accordance with one implementation of the invention

### ILLUSTRATIVE COMPUTING ENVIRONMENT OF THE INVENTION

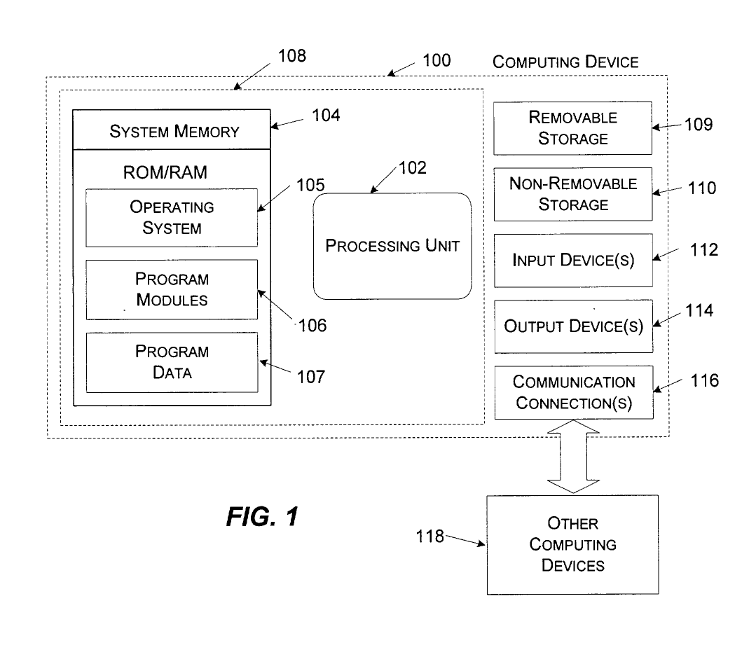

FIG. 1 illustrates an exemplary computing device that may be included in various forms in systems implementing the invention. In a very basic configuration, computing device 100 typically includes at least one processing unit 102 and system memory 104. Processing unit 102 includes existing physical processors, those in design, multiple processors acting together, virtual processors, and any other device or software program capable of interpreting binary executable instructions. Depending on the exact configuration and type of computing device, system memory 104 may be volatile (such as RAM), non-volatile (such as ROM, flash memory, etc.) or some combination of the two. System memory 104 typically includes an operating system 105, one or more program modules 106, and may include program data 107. This basic configuration is illustrated in FIG. 1 by those components within dashed line 108.

Computing device 100 may also have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included. All these devices are known in the art and need not be discussed at length here.

Computing device 100 may also contain communications connection(s) 116 that allow the device to communicate with other computing devices 118, such as over a network. Communications connection(s) 116 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

### DETAILED DESCRIPTION OF EMBODIMENTS OF THE INVENTION

The invention enables an infrastructure for manipulating messages communicated over a distributed network. In one implementation, a Web extensions framework is enabled that allows an incoming message to be manipulated as a stream of information prior to being transformed into an object and passed to a Web service. Likewise, an outgoing message may be manipulated after being transformed from an object into a stream of information for transmission over a distributed network. These manipulations are performed by a module of code that may be accessible either globally, such as for each call to a Web service, or for particular calls to the Web service, such as for one or more individual methods of the Web service.

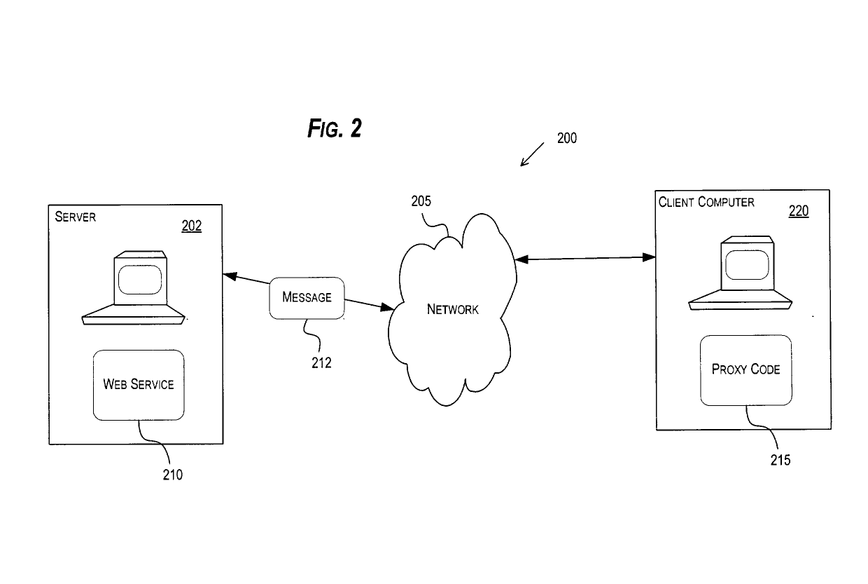

FIG. 2 is a functional block diagram overview of a distributed networking environment 200 in which implementations of the invention may be embodied. As illustrated in FIG. 2, two or more computers, such as a server 202 and a client computer 220, are connected over a wide area network 205, such as the Internet. The server 202 and the client computer 220 may both be examples of the computing device 100 described above in conjunction with FIG. 1.

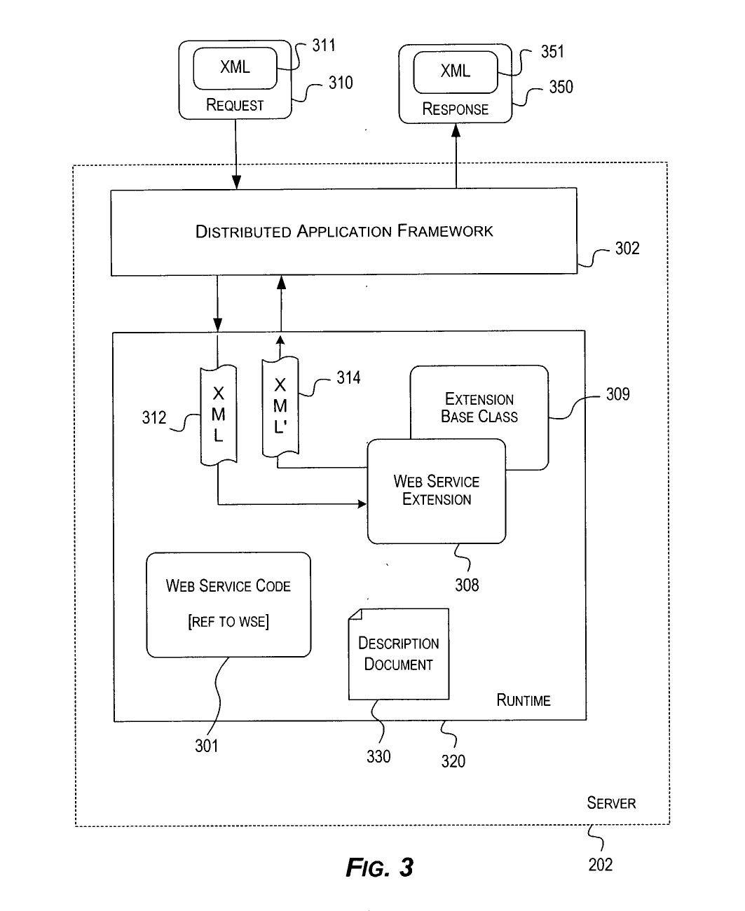

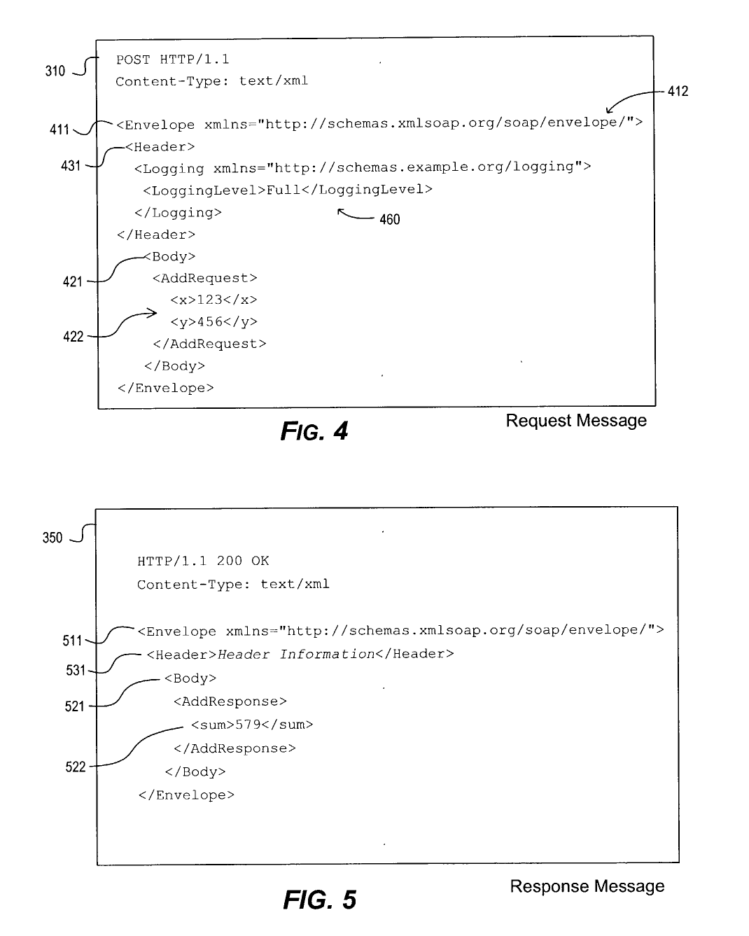

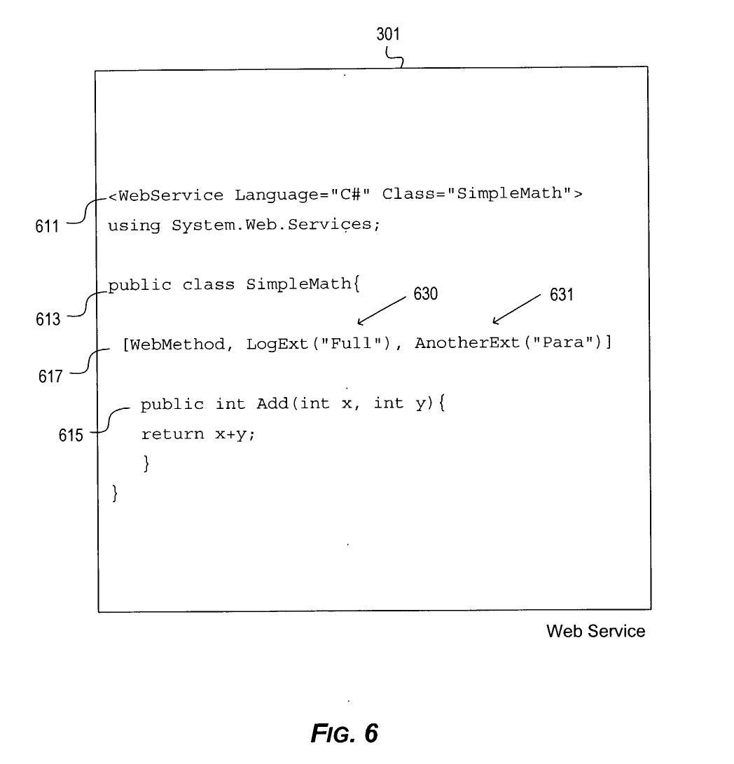

Resident on the server 202 is a Web service 210, which includes code to make available some service or functionality over the network 205. The Web service 210 is described in greater detail in conjunction with FIG. 3. Briefly stated, the Web service 210 is programmed to expose certain code which may be executed by incoming messages (e.g., message 212) from other computers, such as the client computer 220. The Web service 210 may return other messages to the requesting computer in response to being executed. The exchanged messages 212 may be constructed in accordance with an XML-based protocol for creating structured documents, such as the SOAP protocol. FIGS. 4 and 5 illustrate examples of SOAP messages that may be transmitted between the server 202 and the client computer 220. Although described here in terms of the SOAP protocol, any similar protocol for creating structured documents that remotely execute code may be used. Reference to SOAP is for illustrative purposes only and should not be viewed as limiting the scope of the invention.

Resident on the client computer 220 may be executable code (proxy code 215) that acts as a distributed portion of the Web service 210. Although sometimes not necessary, the proxy code 215 may be created either prior to or in connection with interacting with the Web service 210. It will be appreciated that the proxy code 215 may also represent executable code that is capable of interacting with the Web service 210 although not strictly part of a distributed application.

Briefly stated, the proxy code 215 and the Web service 210 communicate over the network 205 using serialized messages 212. Typically, the messages 212 include information that either requests an action to be performed, data to be returned, or both. Also typically the communication may include a request message issued by one computer and a response message issued by the other computer in reply to the request. As described in greater detail below, the Web service 210 or the proxy code 215 or both are constructed in accordance with an infrastructure that allows additional functionality to be “plugged in” and declared for use by the Web service 210, the proxy code 215, or both.

FIG. 3 is a functional block diagram illustrating software components that support the Web service offered by the server 202 and used by the client computer 220. A distributed application framework 302 acts as an interface between messages transported over a network, such as the Internet, and code that executes locally on the computer. The distributed application framework 302 may interact with other lower level network components, such as network communication drivers, to communicate over the network. The distributed application framework 302 receives incoming serialized messages (request message 310) from other computers over the network. The requests 310 typically contain XML code 311 describing some action to be taken by the server 202 or data to be exchanged with the server 202. One illustrative incoming serialized message is described in greater detail later in conjunction with FIG. 4.

The distributed application framework 302 is programmed to deserialize incoming messages and convert the stored XML code 311 to object code for presentation to components executing within a runtime environment 320. For instance, in conventional manner, the distributed application framework 302 is programmed to receive the request message 310, convert the embedded XML code 311 to object code and present it to locally executing components, such as the Web service code 301. The distributed application framework 302 is also programmed to serialize information intended for transmission in outgoing messages, such as the XML code 351 within the response 350. One illustrative outgoing serialized message is described in greater detail below in conjunction with FIG. 5.

Moreover, in accordance with the invention, the distributed application framework 302 is further programmed to make available the XML code 311/351 within the serialized request message 310 or the serialized response 350 to components executing in the runtime environment 320. In one implementation, the distributed application framework 302 is programmed to issue events that instruct code executing within the runtime environment 320 to handle the contents of a message. Those events may be issued at each of multiple stages during the process of transmitting or receiving a message. For example, in one implementation, the distributed application framework 302 is programmed to issue an event instructing code to process an incoming message before the message is deserialized, and to issue another event instructing code to process the incoming message after the message has been deserialized. Likewise, the distribute application framework 302 is programmed to issue an event instructing code to process an outgoing message before the message is serialized, and to issue another event instructing code to process the outgoing message after it has been serialized.

To support these instructions, the distributed application framework 302 makes available a stream of information 312 corresponding to an incoming message prior to being deserialized. Any code that receives the incoming stream 312 is responsible for returning to the distributed application framework 302 another stream of information 314 after any processing has occurred. The returned stream 314 is then either deserialized into objects for presentation to the code within the runtime environment 320, or encapsulated in a response message 350 and transmitted over the network to a client computer.

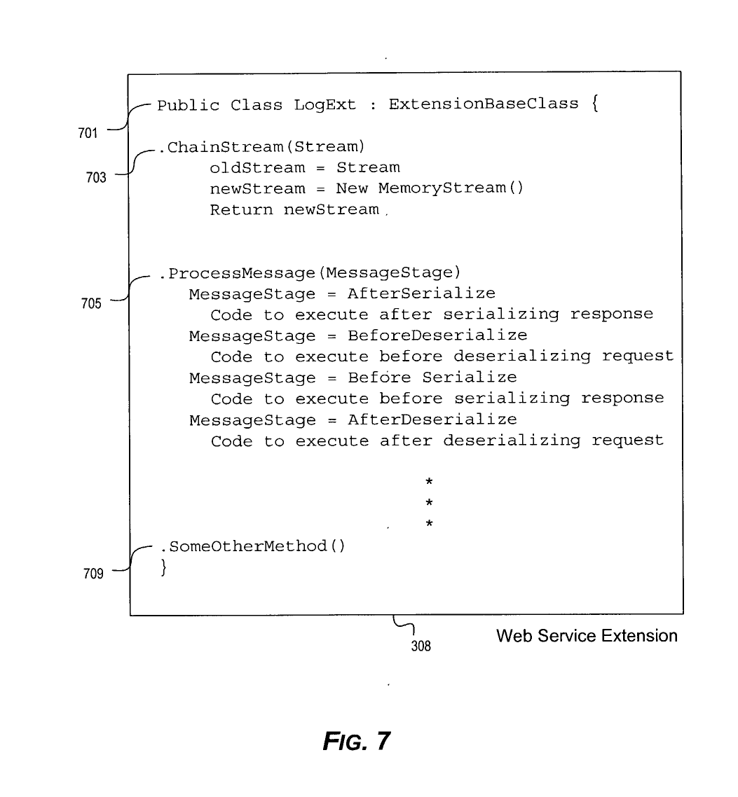

Also resident on the server 202 is Web service code 301 for providing the Web service. Those skilled in the art will appreciate that the Web service code 301 may include classes of objects that are programmed to make some functionality available over a wide area network, such as the Internet. The Web service code 301 is described in greater detail later in conjunction with FIG. 6. Briefly stated, the Web service code 301 includes one or more methods that are identified as available for execution by components over a wide area network. The Web service code 301 receives objects from the distributed application framework 302 corresponding to incoming messages. Likewise, the Web service code 301 passes objects to the distributed application framework 302 for transmission as serialized messages over the network.

Unlike conventional solutions, certain methods within the Web service code 301 may also identify extension code, such as the Web service extension 308, that is provided to add functionality to the Web service code 301. More specifically, a method in the Web service code 301 may include a statement indicating that the Web service extension 308 should be invoked for each call to that method. In this way, external code (the Web service extension 308) may be declaratively invoked to add functionality to the Web service code 301 with little to no modification of the Web service code 301 other than to include a reference to the external code. In the situation where multiple Web service extensions are identified for a particular method, a priority may be assigned to each statement that invokes a Web service extension, thereby allowing the Web service code developer to control the order of execution of each Web service extension, e.g., each Web service extension may be invoked in order of its respective priority.

As mentioned, the Web service extension 308 includes code to add some functionality to the Web service code 301. The Web service extension 308 may be provided by a third-party developer or may be developed in conjunction with the Web service code 301. Logging, encryption, and compression are but a few examples of the many types of extensions that may be added. The construct of the Web service extension 308 is described in greater detail below in conjunction with FIG. 7. However, in short, the Web service extension 308 is configured to receive from the distributed application framework 302 the incoming stream 312. As discussed above, the stream 312 may correspond to the XML code 311 from the incoming message (request message 310) prior to deserialization, or to the XML code 351 for the outgoing message (response 350) after serialization has occurred. The Web service extension 308 is further configured to process that information and return the processed information to the distributed application framework 302 as a return stream 314.

As described in greater detail below, the Web service extension 308 may derive from a Web service extension base class 309 that includes the basic functionality of a Web service extension. The Web service extension 308 then overrides certain methods or properties of the base class 309 in order to implement the specific extension functionality.

A description document 330 may also be available in connection with the Web service code 301. The description document 330 may be an XML-based document that includes a description of the functionality of the Web service and particulars about interacting with the Web service. The description document 330 may be used to describe the Web service, specify its location, and describe the operations (e.g., the methods) exposed by the Web service. One exemplary language that may be used to construct the description document 330 is the Web Services Description Language (WSDL), which is known in the art. The description document 330 is typically constructed dynamically in response to a request for a description of the Web service received by the distributed application framework 302. At this point, the runtime environment 320 may allow each registered Web service extension, such as Web service extension 308, to participate in the process of creating the description document 330.

Using this architecture, when a client computer, such as client computer 220 (FIG. 2), begins to interact with the Web service, it will first receive the description document 330 that describes how clients should interact with the Web service. Because each registered Web service extension participates in the creation of the description document 330 on the server 202, complementary extensions or functionality may be implemented on the client computer 220 based on the description document 330. In other words, when a client computer receives the description document 330, proxy code 215 (FIG. 2) may be created on the client computer 220 to interact with the Web service code 301. The proxy code 215 is created by allowing each registered module of code on the client computer 220 to evaluate the received description document 330 and determine whether to participate in the Web service transactions. More specifically, if a Web service extension is resident on the client computer 220 that has been identified in the description document 330, that Web service extension annotates the proxy code 215 in order to have itself invoked in conjunction with particular methods, as described in the description document 330.

Typically, Web service extensions reside on both the server 202 and the client computer 220. For instance, if a compression extension is used at the server 202 to compress a serialized message, a decompression extension should be used at the client computer 220 prior to deserialization. However, the extension may reside on only one or the other computer in some applications, such as in the case of logging messages or the like.

The described infrastructure enables a developer to build a Web service that provides certain functionality over the network. Client computers may interact directly with methods and properties of the Web service by issuing serialized messages over the network. The developer may then add supplemental functionality (e.g., logging, compression, encryption, or the like) to the Web service without the need to substantially modify the core Web service code. Moreover, that supplemental functionality may be added to the Web service code on a per-method basis, providing the developer with great flexibility in the design of the Web service.

FIG. 4 illustrates one example of a request message 310 that may be used in the operation of implementations of the present invention. It will be appreciated that the example request message 310 shown in FIG. 4 is a greatly simplified message based on the SOAP protocol. As described above in greater detail, SOAP is a remote procedure calling protocol that works over HTTP. Although described in terms of a SOAP-based message, it will be appreciated that messages transmitted in other formats will be equally capable of functioning with embodiments of the invention. The request message 310 is an XML-based message that includes a plurality of elements. In accordance with the SOAP protocol, the request message 310 includes at least an envelope element 411 and a body element 421. The request message 310 may also include a header element 431.

The envelope element 411 encompasses the entire request message 310 and identifies the message as a SOAP message. In accordance with the SOAP protocol, namespace information, such as SOAP namespace 412, may be included that indicates the message is a SOAP message. The envelope element 411 may also include additional attributes of the message.

The body element 421 identifies the particular method or procedure to execute on the remote computer. In this implementation, the name of the body element is the name of the procedure call. In accordance with the invention, the procedure or method identified in the body element 421 corresponds with the procedure or method that has been made available for remote execution and which has an associated Web service extension.

The elements contained within the body element 421 are the parameters 422 to be passed to the procedure. The names of the parameters 422 is significant, the order is not. The parameters 422 can be scalars, strings, dates, structures, arrays, null values, and the like. In this example, a procedure named “Add” will be executed remotely and passed the parameters “123” as “x” and “456” as “y.”The header element 431 is an optional element that provides a flexible mechanism for extending a message in a decentralized and modular way without prior knowledge between the communicating components. Elements of the optional header element 431 may be used to determine how a recipient of a SOAP message should process the message 310. In many cases, a Web service extension my contribute one or more elements to the header element 431 before transmission, or may interpret elements within the header element 431 when a message is received. An example of the use of the header element 431 is the passing of a LoggingLevel element 460 that includes information useful by a receiving Web service extension.

FIG. 5 illustrates one example of a response message 350 that may be used in the operation of implementations of the present invention. Similar to the request message 310, the response message 350 also includes an envelope element 511, a body element 421, and an optional header element 531. The envelope element 511 and the header element 531 function similarly to the equivalent elements described in the request message 310. However, the body element 521 of the response message 350 includes an element indicating that it is a return value generated by the procedure or method identified in the body element 421 of the request message 310. The sub-element 522 of that element includes the return value.

FIG. 6 illustrates one simple example of Web service code 301 that may implement a portion of one embodiment of the present invention. For the purpose of illustration, the Web service code 301 is represented by simplified pseudo code defining methods that execute locally, such as within the runtime environment 320 (FIG. 3), to provide functionality over a network. In one implementation, the Web service code 301 is written in the C Sharp (C#) programming language, as indicated on the first line 611 of code.

The Web service code 301 includes a statement 613 to define a class that includes the methods and properties of the Web service. In this example, a public class named “SimpleMath” is being created. In addition, another statement 615 defines a method in the SimpleMath class named “Add” for adding two integers and returning the sum. The parameters of the Add method are an integer “x” and another integer “y.” Referring briefly to the illustrative request message 310 (FIG. 4), note that the parameters “x” and “y” are passed in the request message as sub-elements of the AddRequest body element 421. Note also that the sum is returned in the response message 350 (FIG. 5) as a sub-element of the AddResponse body element 521.

In accordance with the invention, the Web service code 301 also includes an annotation field 617 that includes attributes to be associated with the particular method following the annotation field 617 (the Add method in this example). The annotation field 617 provides a mechanism by which the Web service code 301 may be annotated with information that may be used by the runtime environment 320 during execution. In particular, the term “WebMethod” may indicate that the particular method with which the attribute 617 is associated (the Add method 615) is to be available for execution by remote calls over the network. Although not illustrated, other methods may also be included in the SimpleMath class which are not made available for remote execution. In those cases, the WebMethod attribute would be omitted.

In addition to the WebMethod attribute, the annotation field 617 may include other attributes (first extension attribute 630 and second extension attribute 631) defining extension code to be invoked when the corresponding method is called. These attributes are recognized by the runtime environment 302 when the class is compiled and executed. In that way, if a call to a particular method is received, the runtime environment identifies any other code that has been identified for execution in conjunction with the called method and executes that code. Each extension identified in the annotation field 617 is executed in the order in which the extension appears. In the current example, each time the Add method is called by a remote message, a procedure named “LogExt” will be called with certain parameters defined in the first extension attribute 630, and then a procedure named “AnotherExt” will be called with the parameters identified in the second extension attribute 631.

Because each method in the SimpleMath class may or may not have the WebMethod attribute, the framework enabled by the invention allows extensions to be applied on a per-method basis. This provides great flexibility to developers to add functionality to the Web service code 301 by simply installing the Web service extension code in the runtime environment and by including a reference to it in the annotation field of any affected methods.

The illustrative Web service code 301 includes only a single method and that method is exposed to network users. It will be appreciated that the illustrative Web service code 301 is an extremely simple example of the functionality that may be provided by a Web service, and that many other methods and properties are likely to be defined within actual code implementing practical Web services.

It should be noted that the proxy code 215 (FIG. 2) may closely resemble the Web service code 301 just described. In particular, the proxy code 215 also may include methods that are configured for remote execution, and may include annotations to invoke locally-stored extension code when those methods are called. In that case, the proxy code 215 may be created by evaluating a description document downloaded from a Web service provider in conjunction with a transaction. Typically, the proxy code 215 is configured to integrate with the Web service code 301 and likely includes complementary procedures.

FIG. 7 illustrates one example of a Web service extension 308 that may implement a portion of one embodiment of the present invention. In this implementation, the Web service extension 308 includes code to perform some function on either an incoming or outgoing message. The Web service extension 308 may be a class of code that derives from a Web service extension base class (not shown) to inherit its core functionality. As shown in the Figure at element 701, the Web service extension 308 inherits code from ExtensionBaseClass. Alternatively, but less preferably, the Web service extension 308 could be written entirely as a stand alone class.

The Web service extension 308 of the described implementation includes at least two methods that may override methods from the base class. In particular, a ChainStream function 703 may be included in the Web service extension 308 that receives as a parameter a stream of information (an input stream) and returns another stream of information (an output stream). It is through the ChainStream function 703 that the Web service extension 308 receives the pertinent message. In the deserialization case, the ChainStream parameter identifies an input stream 312 that is provided by the distributed application framework 302 and represents the XML code 311 associated with an incoming serialized message (see FIG. 3). The output stream 314 represents a stream of information in which the modified XML code will be returned. In the serialization case, the parameter that is passed may represent a currently-empty stream of data into which the modified serialized information is written by the .ChainStream function 703, and the return stream represents a currently-empty stream into which will be written the unmodified serialized information.

The Web service extension 308 also includes a ProcessMessage method 705 that receives as a parameter a MessageStage value. The ProcessMessage method 705 is the method that is called by the distributed application framework 302 or the runtime environment 320 to process the pertinent message at each of several stages. The MessageStage parameter identifies at what point in the process of serializing and deserializing messages the .ProcessMessage method gets called. More specifically, the .ProcessMessage method may be called at each of four stages of the process. When an incoming request message is received, the .ProcessMessage method may be called prior to deserializing the message, as indicated in the Figure by “MessageStage=BeforeDeserialize,” and after deserializing the message, by “MessageStage=AfterDeserialize.” Likewise, when an outgoing message is being prepared for transmission, the .ProcessMessage method may be called prior to serializing the message, as indicated in the Figure by “MessageStage=BeforeSerialize,” and after serializing the message, as indicated in the Figure by “MessageStage=AfterSerialize.” The Web service extension 308 includes the relevant code under each option to handle the particular case. It will be appreciated that the relevant code may invoke other procedures, or in general operate on the message in any programmable manner. It will also be appreciated that the relevant code should pass unmodified streams to and receive unmodified streams from the Web service extension 308 using the .ChainStream function 703.

In addition to the two procedures described, the Web service extension 308 may include many other methods (e.g., .SomeOtherMethod 709) and properties for providing the functionality of the extension. For example, the other methods may include initialization code for initializing data of the Web service extension 308, and additional methods to support the processing of the message by the .ProcessMessage method 705.

It should be noted that one alternative mechanism to the system just described is the use of a configuration file that may indicate the use of a particular Web service extension with a particular Web service. However, in this case, the Web service extension cannot easily be applied to individuals methods of the Web service code.

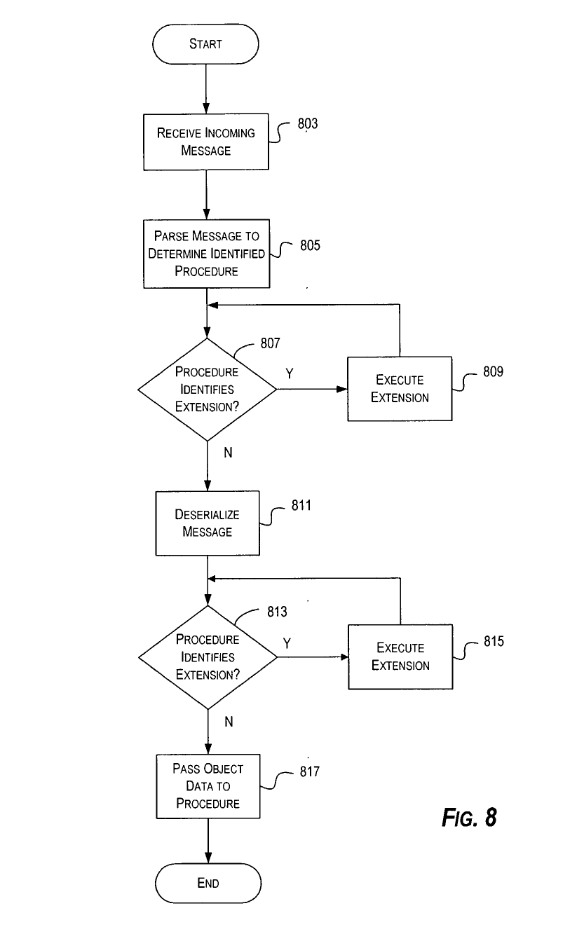

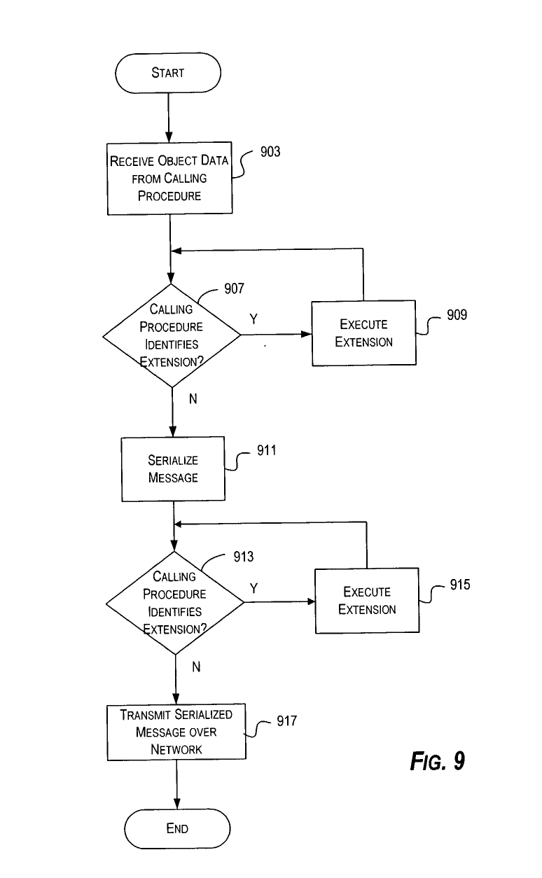

FIG. 8 is a logical flow diagram generally illustrating a process 800 for declaratively invoking identified extension code on a remote computer in a distributed computing environment, in accordance with one implementation of the invention. The process 800 may be implemented in a Web service environment in which serialized messages are transmitted over a network between disparate computing systems, with at least some of the serialized messages including remote procedure calls or the like. The process 800 enters at block 803, where an incoming serialized message is received that is configured to remotely execute a procedure on the receiving computer. In one embodiment, the incoming serialized message may take the form of a SOAP request, such as the request message 310 of FIG. 4, a SOAP response, such as the response message 350 of FIG. 5, or a message in any other suitable serialized data transmission protocol.

At block 805, the received message is parsed to identify the called procedure. Referring to the illustrative request message 310 of FIG. 4, the called procedure may be identified by an element of a body portion of the request message 310. More specifically, the called procedure may be identified by the name of a sub-element of a body element of the received message.

At block 807, a determination is made whether the called procedure identifies an extension for execution in conjunction with executing the called procedure. In the described implementation, this determination may be made by querying whether the called procedure has been annotated with one or more extension attributes in the local code. Alternatively, a configuration file may be present that associates one or more extensions with an entire class of code that supports the Web service. If either case is true, the process 800 proceeds to block 809. If neither case is true, the process 800 proceeds to block 811.

At block 809, the first extension discovered at block 807 is executed. This may be achieved by first invoking a ChainStream method to make available data streams for use in passing the serialized data to and from the identified extension. Then, a .ProcessMessage method may be invoked on the extension with an identifier that the current stage is BeforeDeserialization. In this implementation, executing the extension includes passing a stream of information corresponding to the still-serialized information received over the network. Converting the serialized information to object data does not occur until after the identified extensions have had an opportunity to operate on the serialized message. If multiple extensions are identified through code annotation, each extension may be serially executed in the order of its appearance in the annotated list.

The process 800 loops at blocks 807 and 809 until each extension identified has had an opportunity to operate on the serialized data. Once that loop is complete, the process 800 continues at block 811.

At block 811, the incoming message is deserialized. It will be understood that the operation of deserializing the message may include parsing the message to identify each of a plurality of elements and constructing object data associated with the information in each element. It will also be appreciated that once the deserialization operation has occurred, the message is no longer available as a stream of information, but rather as machine code.

At decision block 813, if the called procedure identified one or more extensions, then those extensions are again executed. Again, each extension identified may be executed during this stage of the process 800 and given the opportunity to operate on the deserialized message (object data) before it is presented to the called procedure. Finally, at block 817, the object data is passed to the called procedure, which executes in its programmed manner.

FIG. 9 is a logical flow diagram generally illustrating a process 900 for declaratively invoking identified extension code on a local computer in a distributed computing environment in conjunction with creating and transmitting a serialized message of a network, in accordance with one implementation of the invention. The process 900 may be implemented in a Web service environment in which serialized messages are transmitted over a network between disparate computing systems, with at least some of the serialized messages including remote procedure calls or the like. The process 900 enters at block 903, where a locally executing procedure is preparing an outgoing message for transmission as a serialized message. The outgoing message may be a request to execute some remote code, or may be a response to a request from the remote code. In the described embodiment, the outgoing serialized message may take the form of a SOAP request, such as the request message 310 of FIG. 4, a SOAP response, such as the response message 350 of FIG. 5, or a message in any other suitable serialized data transmission protocol.

At block 907, a determination is made whether the local procedure constructing the outgoing message identifies an extension for execution in conjunction with procedure. In the described implementation, this determination may be made by querying whether the local procedure has been annotated with one or more extension attributes in the local code. Alternatively, a configuration file may be present that associates one or more extensions with an entire class of code that supports the Web service. If either case is true, the process 900 proceeds to block 909. If neither case is true, the process 900 proceeds to block 911.

At block 909, the first extension discovered at block 907 is executed. This may be achieved by first calling a .ChainStream method on the extension to create streams for use in passing data to and from the extension, and then by calling a .ProcessMessage method on the extension and identifying the current stage as BeforeSerialization. In this implementation, executing the extension at this stage includes passing to the extension the object data constructed by the local procedure prior to being serialized. This provides each extension with an opportunity to operate on the object data prior to the serialized message being constructed. If multiple extensions are identified through code annotation, each extension may be serially executed in the order of its appearance in the annotated list.

The process 900 loops at blocks 907 and 909 until each extension identified has had an opportunity to operate on the object data. Once that loop is complete, the process 900 continues to block 911.

At block 911, the object data constructed by the local procedure is serialized into a message suitable for transmission over the network. The message may take the form of an XML-based message (such as a SOAP message) for remotely issuing a procedure call on another computer or otherwise transmitting data, such as a response to a request for data. It will be appreciated that once the serialization operation has occurred, the object data is only available as a stream of information.

At decision block 913, if the local procedure identified one or more extensions, then those extensions are again executed to operate on the serialized message created at block 911. Again, each extension identified may be executed during this stage of the process 900 and given the opportunity to operate on the now-serialized message as a stream of information prior to being transmitted over the network. Finally, at block 917, the serialized message, with whatever modifications have been performed by the extensions, is transmitted to a remote computer over the network.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A computer-readable medium encoded with computer-executable instructions, comprising:
receiving a message in a first format from a remote location, the message identifying a local procedure for execution;
determining whether extension code is identified for execution in conjunction with the identified local procedure; and
if so, prior to converting the message from the first format to a second format, invoking the identified extension code to operate on at least a portion of the received message.

2. The computer-readable medium of claim 1, further comprising:
if the extension code is identified for execution in conjunction with the identified local procedure, invoking the identified extension code to operate on at least a portion of the received message after converting the message from the first format to the second format.

3. The computer-readable medium of claim 1, wherein the first format comprises a serialized data format, and the second format comprises a deserialized data format.

4. The computer-readable medium of claim 1, wherein the message comprises an eXtensible Markup Language (XML)-based message including at least one element identifying the local procedure.

5. The computer-readable medium of claim 4, wherein the XML-based message comports with the Simple Object Access Protocol.

6. The computer-readable medium of claim 1, wherein determining whether the extension code is identified for execution in conjunction with the identified local procedure further comprises querying a runtime environment for additional information included in a class containing the identified local procedure, the additional information identifying the extension code.

7. The computer-readable medium of claim 6, wherein the additional information comprises an annotation associated with the identified local procedure.

8. The computer-readable medium of claim 1, wherein invoking the identified extension code further comprises issuing a command to the identified extension code including a parameter that indicates the message has not been converted from the first format to the second format.

9. The computer-readable medium of claim 1, further comprising after the identified extension code has operated on the at least portion of the received message, converting the operated-on, received message from the first format to the second format.

10. A computer-readable medium encoded with computer-executable instructions, comprising:
receiving object data in a first format from a locally-executing procedure, the locally-executing procedure identifying extension code for execution in conjunction with the locally-executing procedure;
prior to converting the object data from the first format to a second format, invoking the identified extension code to modify the received object data; and
converting the modified received object data from the first format to a second format.

11. The computer-readable medium of claim 10, further comprising invoking the identified extension code to again modify the received object data after converting the modified received object data from the first format to the second format.

12. The computer-readable medium of claim 10, wherein the second format comprises an eXtensible Markup Language (XML)-based messaging format.

13. The computer-readable medium of claim 12, wherein the XML-based messaging format comprises a Simple Object Access Protocol.

14. The computer-readable medium of claim 10, further comprising transmitting the object data in the second format over a network as a serialized message.

15. A computer-readable medium encoded with computer-executable components for communicating over a network, comprising:
extension code including instructions for performing some function; and
a Web service having at least one method, the method identifying the extension code for execution in conjunction with the method.

16. The computer-readable medium of claim 15, further comprising a runtime environment programmed to determine that the extension code is identified for execution in conjunction with the method and to cause the extension code to execute in response to a call to the method.

17. The computer-readable medium of claim 16, wherein the runtime environment is further configured to pass a serialized message to the extension code in connection with causing the extension code to execute.

18. The computer-readable medium of claim 15, wherein the extension code comprises a class of instructions derived from a base class that includes at least one method for facilitation the execution of the extension code with the Web service.

19. A computer-readable medium encoded with a data structure, comprising:
a first field including computer-executable instructions for performing at least a portion of a Web service in a distributed manner;
a second field associated with the first field and identifying the computer-executable instructions as being available for remote execution; and
a third field associated with the second field and identifying at least one extension for execution in conjunction with the computer-executable instructions.

20. The computer-readable medium of claim 19, wherein the computer-executable instructions comprise a method for providing functionality to the Web service.

21. The computer-readable medium of claim 20, wherein the second field comprises an annotation associated with the method that identifies the method as capable of being executed in response to a remote procedure call.

22. The computer-readable medium of claim 21, wherein the third field comprises another annotation associated with the method that identifies the at least one extension.

23. A computer-readable medium encoded with a data structure, comprising:
a first field including computer-executable instructions for capturing a stream of information associated with a serialized message, the computer-executable instructions being further operative to return a modified stream of information based on processing that occurs by other components of the data structure; and
a second field including computer-executable instructions for processing information during at least one of a plurality of stages, each stage being associated with the state of serialization of the serialized message.

24. The computer-readable medium of claim 23, wherein the plurality of stages comprises a BeforeSerialization stage corresponding to the state of the serialized message prior to being serialized.

25. The computer-readable medium of claim 23, wherein the plurality of stages comprises an AfterSerialization stage corresponding to the state of the serialized message after being serialized but prior to being transmitted.

26. The computer-readable medium of claim 23, wherein the plurality of stages comprises a BeforeDeserialization stage corresponding to the state of the serialized message prior to being deserialized but after receipt.

27. The computer-readable medium of claim 23, wherein the plurality of stages comprises an AfterDeserialization stage corresponding to the state of the serialized message after being deserialized.

28. The computer-readable medium of claim 23, wherein the data structure is derived from another data structure having a set of predefined methods for interacting with a Web service.

29. The computer-readable medium of claim 28, wherein the other data structure comprises a Web service extension base class.
